(19) United States
(12) Patent Application Publication
(10) Pub. No.: US 2021/0042536 A1
(43) Pub. Date: Feb. 11, 2021

(54) IMAGE PROCESSING DEVICE AND IMAGE PROCESSING METHOD

(71) Applicant: Mitsubishi Electric Corporation, Tokyo (JP)

(72) Inventor: Ryosuke SASAKI, Tokyo (JP)

(73) Assignee: Mitsubishi Electric Corporation, Tokyo (JP)

(21) Appl. No.: 16/976,302

(22) PCT Filed: Mar. 1, 2018
(86) PCT No.: PCT/JP2018/007862

§ 371 Date: Aug. 27, 2020

(51) Int. Cl. G06K 9/00; G06T 7/13; G06T 7/60; G06T 5/00; G06T 3/60

(52) U.S. Cl. CPC G06K 9/00798; G06T 7/13; G06T 2207/30256; G06T 5/006; G06T 3/60; G06T 7/60

(57) ABSTRACT

An image processing device detects a road marking from a target image, detects road edges of a road region including the road marking, estimates an angle indicating a direction of a road from slopes of edges of the road edges, rotates the target image depending on the angle indicating the direction of the road and then corrects distortion of the target image, and recognizes the road marking using the corrected target image.

### TECHNICAL FIELD

The invention relates to an image processing device and an image processing method that recognize a road marking.

### BACKGROUND ART

Techniques for automatically recognizing road markings are inevitable to implement vehicle self-driving.

For example, Non-Patent Literature 1 describes a technique for automatically recognizing a road marking using images of the road marking shot at a plurality of angles.

### CITATION LIST

### Non-Patent Literature

Non-Patent Literature 1: Jack Greenhalgh, Majid Mirmehdi, “Detection and Recognition of Painted Road Surface Markings”, ICPRAM 2015 Proceedings of the International Conference on Pattern Recognition Applications and Method Vol. 1, pp. 130-138.

### SUMMARY OF INVENTION

### Technical Problem

The conventional technique described in Non-Patent Literature 1 has a problem that there is a need to prepare images of a road marking shot at a plurality of angles.

The invention is to solve the above-described problem, and an object of the invention is to obtain an image processing device and an image processing method that can automatically recognize a road marking even without using images of the road marking shot at a plurality of angles.

### Solution to Problem

An image processing device according to the invention includes a marking detecting unit, a road edge detecting unit, a road direction estimating unit, an image rotating unit, a distortion correcting unit, and a marking recognizing unit. The marking detecting unit detects a road marking drawn on a road from a target image in which the road marking is shot. The road edge detecting unit detects, from the target image, road edges of a road region including the road marking detected by the marking detecting unit. The road direction estimating unit estimates an angle indicating a direction of the road in the road region, on the basis of slopes of edges of the road edges detected by the road edge detecting unit. The image rotating unit rotates the target image depending on the angle indicating the direction of the road estimated by the road direction estimating unit. The distortion correcting unit corrects distortion of the target image rotated by the image rotating unit. The marking recognizing unit recognizes the road marking using the target image corrected by the distortion correcting unit.

### Advantageous Effects of Invention

According to the invention, the image processing device detects a road marking from a target image, detects road edges of a road region including the road marking, estimates an angle indicating a direction of a road from slopes of edges of the road edges, rotates the target image depending on the angle indicating the direction of the road and then corrects distortion of the target image, and recognizes the road marking using the corrected target image. By this means, the image processing device can automatically recognize a road marking even without using images of the road marking shot at a plurality of angles.

### BRIEF DESCRIPTION OF DRAWINGS

FIG. 1 is a block diagram showing a configuration of an image processing device according to a first embodiment of the invention.

FIG. 2 is a flowchart showing an image processing method according to the first embodiment.

FIG. 3A is a diagram showing an overview of a marking detection process,

FIG. 3B is a diagram showing an overview of a road edge detection process,

FIG. 3C is a diagram showing an overview of a road direction estimation process, and

FIG. 3D is a diagram showing an overview of a rotation and correction process.

FIG. 4 is a block diagram showing a configuration of an image processing device according to a second embodiment of the invention.

FIG. 5 is a flowchart showing an image processing method according to the second embodiment.

FIG. 6A is a diagram showing an overview of a marking detection process,

FIG. 6B is a diagram showing an overview of a road surface segmentation process,

FIG. 6C is a diagram showing an overview of a road direction estimation process, and

FIG. 6D is a diagram showing an overview of a rotation and correction process.

FIG. 7A is a block diagram showing a hardware configuration that implements functions of the image processing device according to the first embodiment or the second embodiment, and

FIG. 7B is a block diagram showing a hardware configuration that executes software that implements the functions of the image processing device according to the first embodiment or the second embodiment.

### DESCRIPTION OF EMBODIMENTS

To describe the invention in more detail, modes for carrying out the invention will be described below with reference to the accompanying drawings.

### First Embodiment

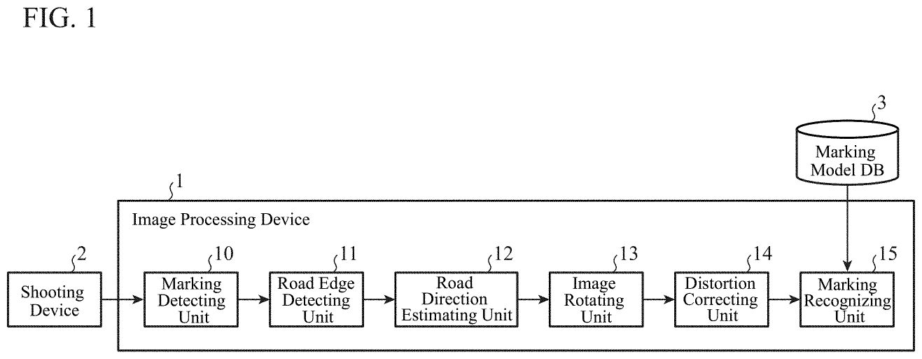

FIG. 1 is a block diagram showing a configuration of an image processing device 1 according to a first embodiment of the invention. The image processing device 1 is mounted on a vehicle, and performs image processing on an image of a road marking shot by a shooting device 2, and thereby creates an image for recognition, and recognizes a type of the road marking on the basis of the content of a marking model database (hereinafter, described as marking model DB) 3 and the image for recognition. As shown in FIG. 1, the image processing device 1 includes a marking detecting unit 10, a road edge detecting unit 11, a road direction estimating unit 12, an image rotating unit 13, a distortion correcting unit 14, and a marking recognizing unit 15.

The shooting device 2 is a device mounted on the vehicle to shoot an area around the vehicle, and is implemented by, for example, a camera or a radar device. An image shoot by the shooting device 2 is outputted to the image processing device 1. The marking model DB 3 has recognition models for road markings registered therein. The recognition models for road markings are learned beforehand for each type of road markings.

For learning of recognition models, a support vector machine (hereinafter, described as SVM) or a convolutional neural network (hereinafter, described as CNN) may be used.

The marking detecting unit 10 detects a road marking from a target image. The target image is an image of a shot road marking, out of images that are shot by the shooting device 2 and inputted to the marking detecting unit 10.

For example, the marking detecting unit 10 performs pattern recognition for road marking on an image inputted from the shooting device 2, and identifies an image area including a road marking which is detected on the basis of a result of the pattern recognition. Data representing the above-described image area and the above-described target image are outputted to the road edge detecting unit 11 from the marking detecting unit 10.

The road edge detecting unit 11 detects, from the target image, road edges of a road region including the road marking which is detected by the marking detecting unit 10. For example, the road edge detecting unit 11 identifies a road region including the road marking in the target image, on the basis of the data representing the above-described image area, the data being inputted from the marking detecting unit 10, and detects white regions present at edge portions of the identified road region, by considering the white regions as white lines drawn at road edges. Data representing the white lines (road edges) detected by the road edge detecting unit 11 and the above-described target image are outputted to the road direction estimating unit 12 from the road edge detecting unit 11.

The road direction estimating unit 12 estimates an angle indicating a direction of a road in the road region, on the basis of the slopes of edges of the road edges detected by the road edge detecting unit 11. For example, the road direction estimating unit 12 extracts edges of a plurality of line segments set along the white lines present at the road edges, and calculates a mean of inclination angles of the edges of the plurality of line segments, by considering the mean as angle data representing the direction of the road. The angle data representing the direction of the road and the above-described target image are outputted to the image rotating unit 13 from the road direction estimating unit 12.

The image rotating unit 13 rotates the target image depending on the angle indicating the direction of the road which is estimated by the road direction estimating unit 12. Since the road marking is drawn on a road surface of the road, in the target image the road marking looks inclined along with a curve of the road.

In addition, it is desirable that the road marking in the rotated target image have the same direction as road markings used to learn recognition models registered in the marking model DB 3.

Hence, when the recognition models are learned using road markings drawn on straight-line roads in an up-down direction, the image rotating unit 13 rotates the target image depending on the angle indicating the direction of the road in such a manner that the road in the target image looks lying in the up-down direction. By this rotation process, the road marking that looks inclined in the target image before rotation is corrected to look lying in the up-down direction in the target image after rotation.

The distortion correcting unit 14 corrects distortion of the target image rotated by the image rotating unit 13. Since the shapes themselves of the road and road marking in the target image are the same as those before the rotation, the shapes look distorted in the rotated target image. Hence, the distortion correcting unit 14 makes a correction to reduce the above-described distortion of the shapes of the road and road marking in the target image having been subjected to the rotation process. For example, the distortion correcting unit 14 extracts edges of the road and road marking from the target image having been subjected to the rotation process, and changes the shapes of the road and road marking on the basis of the extracted edges so as to reduce the above-described distortion.

The marking recognizing unit 15 recognizes the road marking using the target image (image for recognition) corrected by the distortion correcting unit 14. For example, the marking recognizing unit 15 identifies a type of the road marking in the target image having been subjected to the distortion correction, using the recognition models registered in the marking model DB 3.

As such, the image processing device 1 can automatically recognize a road marking using a target image in which the road marking looks lying in a certain direction (e.g., the up-down direction), even without using images of the road marking shot at a plurality of angles.

Next, operation will be described.

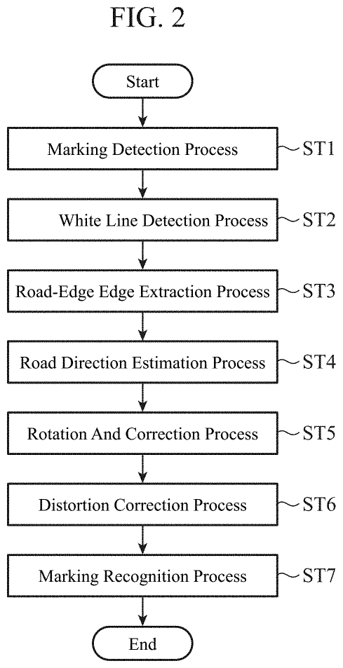

FIG. 2 is a flowchart showing an image processing method according to the first embodiment, and shows a series of processes from detection of a road marking from a target image to recognition of the road marking.

First, the marking detecting unit 10 accepts, as input, an image shot by the shooting device 2, and detects a road marking from the inputted image (step ST1). For example, the marking detecting unit 10 identifies an image area including a road marking by performing pattern recognition for road marking on the inputted image. An image from which the road marking is thus detected is a target image, and the target image and data representing the above-described image area are outputted to the road edge detecting unit 11 from the marking detecting unit 10.

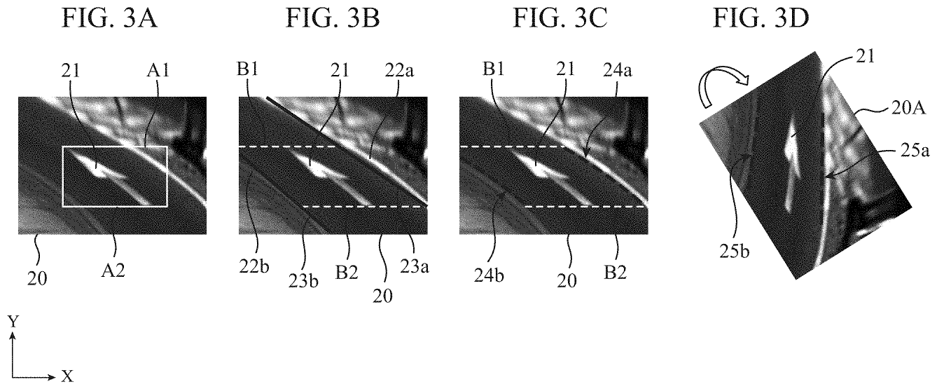

FIG. 3A is a diagram showing an overview of a marking detection process. In a target image 20 shown in FIG. 3A, an arrow-shaped road marking 21 is shot. A road in the target image 20 is a curved road leading from the lower right to the upper left, and the road marking 21 looks inclined along with a curve of the road.

The marking detecting unit 10 performs pattern recognition for road marking on the target image 20, and identifies an image area including the road marking 21 from a result of the recognition.

For example, the marking detecting unit 10 identifies a Y-coordinate A1 of an upper end of the road marking 21 and a Y-coordinate A2 of a lower end of the road marking 21 in the target image 20. The Y-coordinates A1 and A2 are data representing an image area including the road marking 21.

Then, the road edge detecting unit 11 performs a white line detection process on the target image (step ST2). For example, the road edge detecting unit 11 identifies a road region including the road marking in the target image, on the basis of the data representing the above-described image area, the data being inputted from the marking detecting unit 10, and detects white regions present at edge portions of the identified road region, by considering the white regions as white lines.

FIG. 3B is a diagram showing an overview of a road edge detection process. On the road in the target image 20, a white line 22a is drawn at one edge and a white line 22b is drawn at the other edge. The road edge detecting unit 11 identifies a road region including the road marking 21, on the basis of the Y-coordinates A1 and A2 inputted from the marking detecting unit 10. The road region is a region between a broken line B1 drawn at an image location corresponding to the Y-coordinate A1 and a broken line B2 drawn at an image location corresponding to the Y-coordinate A2.

For example, the road edge detecting unit 11 determines a color feature for each pixel in the road region identified from the target image 20, and extracts white regions from the road region on the basis of a result of the determination of a color feature for each pixel. The road edge detecting unit 11 detects white regions 23a and 23b present at edge portions of the road region and along the road, among the white regions extracted from the road region, by considering the white regions 23a and 23b as regions in which the white lines 22a and 22b are shot. Data representing the white regions 23a and 23b detected from the target image 20 by the road edge detecting unit 11 is outputted together with the target image 20 to the road direction estimating unit 12.

The road direction estimating unit 12 extracts edges of the road edges detected by the road edge detecting unit 11 (step ST3). For example, the road direction estimating unit 12 extracts an edge of the white region 23a corresponding to the white line 22a, and extracts an edge of the white region 23b corresponding to the white line 22b.

Then, the road direction estimating unit 12 estimates an angle indicating a direction of the road in the road region, on the basis of the slopes of the edges of the road edges (step ST4).

FIG. 3C is a diagram showing an overview of a road direction estimation process. For example, the road direction estimating unit 12 divides each of the white regions 23a and 23b in the road region including the road marking 21 into small regions for respective line segments lying along a corresponding one of the white lines 22a and 22b. In FIG. 3C, small regions of a plurality of line segments included in the white region 23a are a region group 24a, and small regions of a plurality of line segments included in the white region 23b are a region group 24b.

By using an image feature for each of the small regions included in the region groups 24a and 24b, the road direction estimating unit 12 extracts an edge for each of the small regions. This process is a road-edge edge extraction process.

For example, the road direction estimating unit 12 determines, for each pixel in a small region, the gradient magnitude and gradient direction of a pixel value, and determines Histogram of Oriented Gradients (HOG) features which are a histogram of the gradient directions with respect to the gradient magnitudes of the pixel values. The road direction estimating unit 12 extracts an edge of the small region which is a line segment, using the HOG features, and identifies an angle of the edge (an angle of the line segment). This process is performed for all small regions included in the region groups 24a and 24b.

The road direction estimating unit 12 calculates a value obtained by averaging the angles of the edges of all small regions included in the region groups 24a and 24b, by estimating the value as an angle indicating a direction of the road on which the road marking 21 is drawn. This process is a road direction estimation process. Note that although the mean of the angles of the edges of all small regions included in the region groups 24a and 24b is estimated as the angle indicating the direction of the road, it is not limited thereto. Another statistic such as the maximum value or minimum value of the angles of the edges of the small regions may be used as long as the value is reliable as the angle indicating the direction of the road.

Then, the image rotating unit 13 rotates the target image depending on the angle indicating the direction of the road (step ST5). For example, when the recognition models for road markings are learned using road markings drawn on straight-line roads in the up-down direction, the image rotating unit 13 rotates the target image depending on the angle indicating the direction of the road in such a manner that the road in the target image looks lying in the up-down direction. This process is a rotation and correction process.

FIG. 3D is a diagram showing an overview of the rotation and correction process. As shown in FIGS. 3A, 3B, and 3C, the direction of the road in the target image 20 is the direction going from the lower right to the upper left. The image rotating unit 13 rotates the target image 20 depending on the angle indicating the direction of the road in such a manner that the road looks lying in the up-down direction. In a rotated target image 20A, the road looks lying in the up-down direction. Note that region groups 25a and 25b each include small regions of a corresponding one of the road edges, and edges of the small regions lie in the up-down direction.

Then, the distortion correcting unit 14 corrects distortion of the target image rotated by the image rotating unit 13 (step ST6). For example, the distortion correcting unit 14 extracts edges of the road marking 21 from the target image 20A having been subjected to the rotation process, and changes the shape of the road marking on the basis of the extracted edges so as to eliminate distortion of the road marking 21.

The marking recognizing unit 15 recognizes the road marking using the target image corrected by the distortion correcting unit 14 (step ST7). For example, the marking recognizing unit 15 receives the target image corrected by the distortion correcting unit 14, as an image for recognition, and identifies a type of the road marking using the recognition models registered in the marking model DB 3 and the image for recognition.

As described above, the image processing device 1 according to the first embodiment detects a road marking from a target image, detects road edges of a road region including the road marking, estimates an angle indicating a direction of a road from the slopes of edges of the road edges, rotates the target image depending on the angle indicating the direction of the road and then corrects distortion of the target image, and recognizes the road marking using the corrected target image. By this, the image processing device 1 can automatically recognize a road marking even without using images of the road marking shot at a plurality of angles.

In the image processing device 1 according to the first embodiment, the road edge detecting unit 11 detects white lines in the road region from the target image. The road direction estimating unit 12 considers the white lines as road edges, and estimates an angle indicating the direction of the road in the road region on the basis of the slopes of edges of the white lines. By this means, the road edge detecting unit 11 can accurately detect the road edges of the road region including the road marking.

In the image processing device 1 according to the first embodiment, the road direction estimating unit 12 estimates an angle indicating the direction of the road, on the basis of a statistic (e.g., a mean) of the slopes of a plurality of line segments lying along the road edges. By this means, the road direction estimating unit 12 can estimate a value reliable as the angle indicating the direction of the road on which the road marking is drawn.

### Second Embodiment

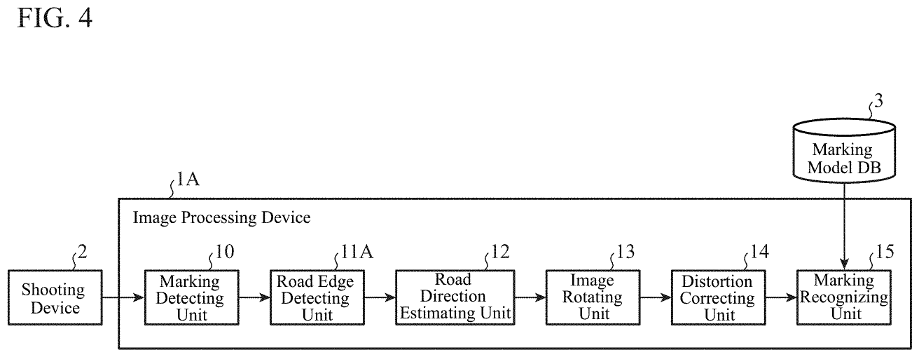

A second embodiment describes a process of detecting road edges of a road on which white lines are not drawn. FIG. 4 is a block diagram showing a configuration of an image processing device 1A according to the second embodiment.

The image processing device 1A is mounted on a vehicle, and performs image processing on an image of a road marking shot by the shooting device 2, and thereby creates an image for recognition, and recognizes a type of the road marking on the basis of the content of the marking model DB 3 and the image for recognition. As shown in FIG. 4, the image processing device 1A is configured to include the marking detecting unit 10, a road edge detecting unit 11A, the road direction estimating unit 12, the image rotating unit 13, the distortion correcting unit 14, and the marking recognizing unit 15. Note that in FIG. 4 the same components as those of FIG. 1 are given the same reference signs and description thereof is omitted.

The road edge detecting unit 11A estimates a road region in a target image on the basis of attributes for respective pixels of the target image, and detects road edges of the estimated road region from the target image. For example, the road edge detecting unit 11A estimates a road region in a target image on the basis of attributes for respective pixels of the target image, extracts edges from the estimated road region, and detects road edges on the basis of the extracted edges.

Next, operation will be described.

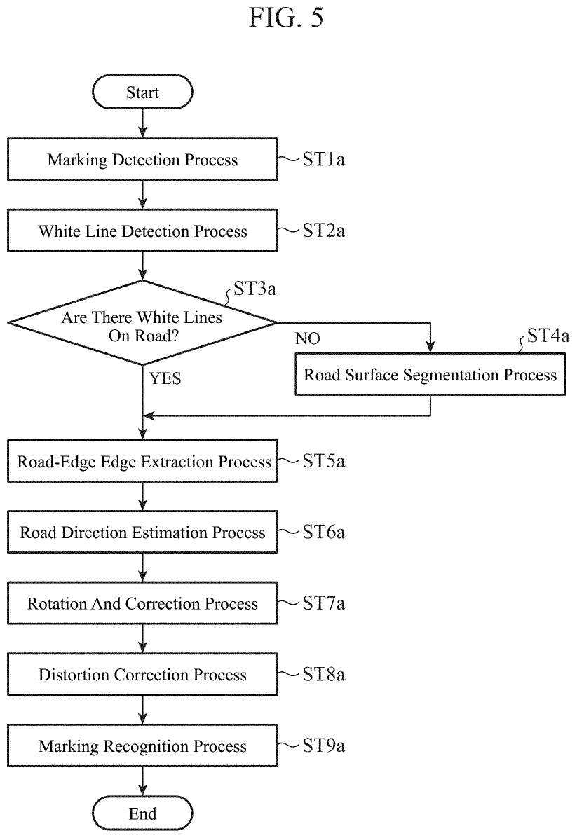

FIG. 5 is a flowchart showing an image processing method according to the second embodiment, and shows a series of processes from detection of a road marking from a target image to recognition of the road marking.

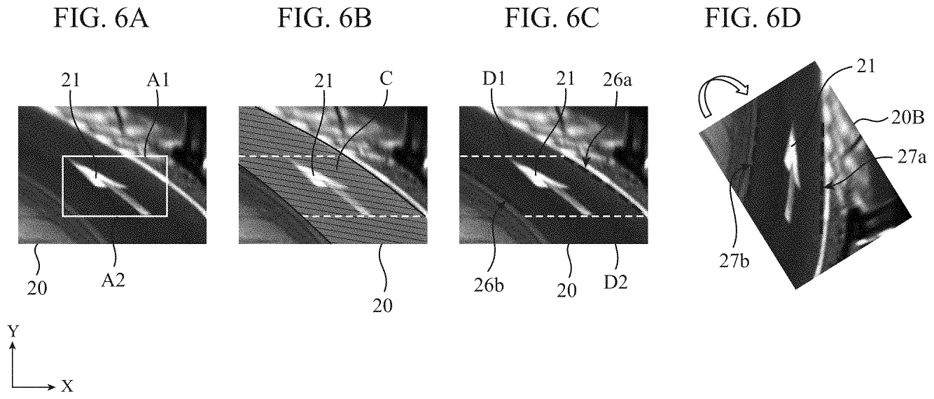

First, the marking detecting unit 10 accepts, as input, an image shot by the shooting device 2, and detects a road marking from the inputted image (step ST1a). FIG. 6A is a diagram showing an overview of a marking detection process. The marking detecting unit 10 identifies a Y-coordinate A1 of an upper end of a road marking 21 and a Y-coordinate A2 of a lower end of the road marking 21 in a target image 20, by the same procedure as that of the first embodiment.

The road edge detecting unit 11A performs a white line detection process on a target image (step ST2a). For example, the road edge detecting unit 11A identifies a road region including the road marking in the target image on the basis of the data representing the above-described image area, the data being inputted from the marking detecting unit 10, and searches for white regions in the identified road region.

Then, the road edge detecting unit 11A determines whether or not there are white lines on a road in the target image (step ST3a). For example, the road edge detecting unit 11A determines whether or not the white regions extracted from the road region as described above include white regions corresponding to white lines. The white regions corresponding to white lines are white regions present at edge portions of the road region and along the road. Here, since white lines are not drawn on the road, white regions are not detected from the edge portions of the road region.

If there are no white lines on the road in the target image (step ST3a; NO), the road edge detecting unit 11A performs a road surface segmentation process on the target image (step ST4a).

The road surface segmentation process is so-called semantic segmentation that determines attributes for respective pixels of the target image and estimates a road image region from results of the determination of the attributes.

FIG. 6B is a diagram showing an overview of the road surface segmentation process. For example, the road edge detecting unit 11A determines, for each of the pixels of the target image 20, which object's attribute a corresponding one of the pixels has, by referring to dictionary data for identifying objects in an image. The dictionary data is data for identifying objects in an image on a category-by-category basis, and is learned beforehand. The categories include ground objects such as a road and a building, and objects that can be present outside the vehicle such as a vehicle and a pedestrian.

The road edge detecting unit 11A extracts a region including pixels determined to have a road attribute among the pixels of the target image 20, by considering the region as a road region C. Then, the road edge detecting unit 11A identifies a road region including the road marking 21 from among the extracted road region C, on the basis of the Y-coordinates A1 and A2 inputted from the marking detecting unit 10. Subsequently, the road edge detecting unit 11A detects regions of boundary portions for regions including pixels that do not have a road attribute, from among the identified road region, by considering the regions of boundary portions as regions corresponding to road edges. Data representing the regions corresponding to road edges which are detected from the target image 20 by the road edge detecting unit 11A is outputted together with the target image 20 to the road direction estimating unit 12.

If there are white lines on a road in the target image (step ST3a; YES) or if the process at step ST4a is completed, the road direction estimating unit 12 extracts edges of the road edges detected by the road edge detecting unit 11A (step ST5a).

Subsequently, the road direction estimating unit 12 estimates an angle indicating a direction of the road in the road region, on the basis of the slopes of the edges of the road edges (step ST6a).

FIG. 6C is a diagram showing an overview of a road direction estimation process. For example, the road direction estimating unit 12 divides each of the regions corresponding to the road edges into small regions for respective line segments lying along the road. Here, the road region is a region between a broken line D1 drawn at an image location corresponding to the Y-coordinate A1 and a broken line D2 drawn at an image location corresponding to the Y-coordinate A2. In FIG. 6C, small regions of a plurality of line segments included in a region corresponding to one road edge are a region group 26a, and small regions of a plurality of line segments included in a region corresponding to the other road edge are a region group 26b.

By using an image feature for each of the small regions included in the region groups 26a and 26b, the road direction estimating unit 12 extracts an edge for each of the small regions, by the same procedure as that of the first embodiment. This process is performed for all small regions included in the region groups 26a and 26b. Then, the road direction estimating unit 12 calculates a value obtained by averaging the angles of the edges of all small regions included in the region groups 26a and 26b, by estimating the value as an angle indicating a direction of the road on which the road marking 21 is drawn.

Then, the image rotating unit 13 rotates the target image depending on the angle indicating the direction of the road (step ST7a). FIG. 6D is a diagram showing an overview of a rotation and correction process. For example, when the recognition models for road markings are learned using road markings drawn on straight-line roads in the up-down direction, the image rotating unit 13 rotates the target image 20 in such a manner that the edges of all small regions included in the region groups 26a and 26b lie in the up-down direction. By this means, in a rotated target image 20B, the road in the image looks lying in the up-down direction. Note that region groups 27a and 27b each include small regions of a corresponding one of the road edges, and edges of the small regions lie in the up-down direction.

Then, the distortion correcting unit 14 corrects distortion of the target image rotated by the image rotating unit 13, by the same procedure as that of the first embodiment (step ST8a). For example, the distortion correcting unit 14 extracts edges of the road marking 21 from the target image 20B having been subjected to the rotation process, and changes the shape of the road marking on the basis of the extracted edges so as to eliminate distortion of the road marking 21.

Finally, the marking recognizing unit 15 recognizes the road marking using the target image corrected by the distortion correcting unit 14, by the same procedure as that of the first embodiment (step ST9a). For example, the marking recognizing unit 15 receives the target image corrected by the distortion correcting unit 14, as an image for recognition, and identifies a type of the road marking using the recognition models registered in the marking model DB 3 and the image for recognition.

As described above, in the image processing device 1A according to the second embodiment, the road edge detecting unit 11A determines attributes for respective pixels of a target image, determines a road region in the target image on the basis of results of the determination of the attributes for the respective pixels, and detects road edges of the estimated road region.

By performing this process, even when white lines are not drawn on a road, the road edge detecting unit 11A can accurately detect road edges of a road region including a road marking.

In addition, as in the first embodiment, the image processing device 1A can automatically recognize a road marking using a target image in which the road marking looks lying in a certain direction (e.g., the up-down direction), even without using images of the road marking shot at a plurality of angles.

### Third Embodiment

Functions of the marking detecting unit 10, the road edge detecting unit 11, the road direction estimating unit 12, the image rotating unit 13, the distortion correcting unit 14, and the marking recognizing unit 15 in the image processing device 1 are implemented by a processing circuit. Namely, the image processing device 1 includes a processing circuit for performing the processes at step ST1 to ST7 shown in FIG. 2. Likewise, functions of the marking detecting unit 10, the road edge detecting unit 11A, the road direction estimating unit 12, the image rotating unit 13, the distortion correcting unit 14, and the marking recognizing unit 15 in the image processing device 1A are implemented by a processing circuit, and the processing circuit is to perform the processes at step ST1a to ST9a shown in FIG. 5. These processing circuits may be dedicated hardware or may be a Central Processing Unit (CPU) that executes programs stored in a memory.

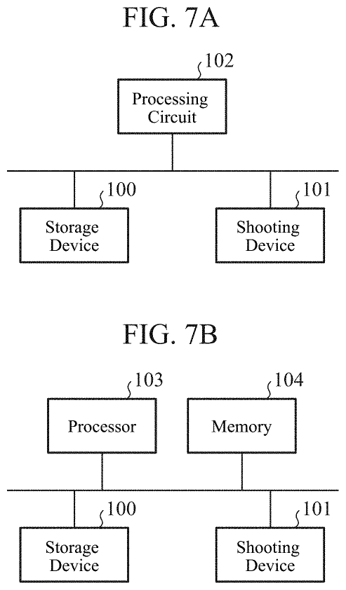

FIG. 7A is a block diagram showing a hardware configuration that implements the functions of the image processing device 1 or the image processing device 1A. FIG. 7B is a block diagram showing a hardware configuration that executes software that implements the functions of the image processing device 1 or the image processing device 1A. In FIGS. 7A and 7B, a storage device 100 is a storage device that stores the marking model DB 3. The storage device 100 may be a storage device provided independently of the image processing device 1 or the image processing device 1A. For example, the image processing device 1 or the image processing device 1A may use the storage device 100 present on a cloud network. A shooting device 101 is the shooting device shown in FIGS. 1 and 4, and is implemented by a camera or a radar device.

When the above-described processing circuits correspond to a processing circuit 102 which is dedicated hardware shown in FIG. 7A, the processing circuit 102 corresponds, for example, to a single circuit, a combined circuit, a programmed processor, a parallel programmed processor, an Application Specific Integrated Circuit (ASIC), a Field-Programmable Gate Array (FPGA), or a combination thereof.

The functions of the marking detecting unit 10, the road edge detecting unit 11, the road direction estimating unit 12, the image rotating unit 13, the distortion correcting unit 14, and the marking recognizing unit 15 in the image processing device 1 may be implemented by different processing circuits, or may be collectively implemented by a single processing circuit.

In addition, the functions of the marking detecting unit 10, the road edge detecting unit 11A, the road direction estimating unit 12, the image rotating unit 13, the distortion correcting unit 14, and the marking recognizing unit 15 in the image processing device 1A may be implemented by different processing circuits, or may be collectively implemented by a single processing circuit.

When the above-described processing circuits correspond to a processor 103 shown in FIG. 7B, the functions of the marking detecting unit 10, the road edge detecting unit 11, the road direction estimating unit 12, the image rotating unit 13, the distortion correcting unit 14, and the marking recognizing unit 15 in the image processing device 1 are implemented by software, firmware, or a combination of software and firmware. In addition, the functions of the marking detecting unit 10, the road edge detecting unit 11A, the road direction estimating unit 12, the image rotating unit 13, the distortion correcting unit 14, and the marking recognizing unit 15 in the image processing device 1A are also implemented by software, firmware, or a combination of software and firmware. Note that the software or firmware is described as programs and stored in a memory 104.

The processor 103 implements the functions of the marking detecting unit 10, the road edge detecting unit 11, the road direction estimating unit 12, the image rotating unit 13, the distortion correcting unit 14, and the marking recognizing unit 15 in the image processing device 1, by reading and executing the programs stored in the memory 104.

Namely, the image processing device 1 includes the memory 104 for storing programs by which the processes at step ST1 to ST7 shown in FIG. 2 are consequently performed when the programs are executed by the processor 103. These programs cause a computer to perform procedures or methods for the marking detecting unit 10, the road edge detecting unit 11, the road direction estimating unit 12, the image rotating unit 13, the distortion correcting unit 14, and the marking recognizing unit 15.

The memory 104 may be a computer-readable storage medium having stored therein programs for causing the computer to function as the marking detecting unit 10, the road edge detecting unit 11, the road direction estimating unit 12, the image rotating unit 13, the distortion correcting unit 14, and the marking recognizing unit 15.

This is the same for the image processing device 1A, too.

The memory 104 corresponds, for example, to a nonvolatile or volatile semiconductor memory such as a Random Access Memory (RAM), a Read Only Memory (ROM), a flash memory, an Erasable Programmable Read Only Memory (EPROM), or an Electrically-EPROM (EEPROM), a magnetic disk, a flexible disk, an optical disc, a compact disc, a MiniDisc, or a DVD.

Some of the functions of the marking detecting unit 10, the road edge detecting unit 11, the road direction estimating unit 12, the image rotating unit 13, the distortion correcting unit 14, and the marking recognizing unit 15 may be implemented by dedicated hardware, and some of the functions may be implemented by software or firmware.

For example, the functions of the marking detecting unit 10, the road edge detecting unit 11, and the road direction estimating unit 12 are implemented by a processing circuit which is dedicated hardware. In addition, the functions of the image rotating unit 13, the distortion correcting unit 14, and the marking recognizing unit 15 are implemented by the processor 103 reading and executing a program stored in the memory 104. This is the same for the image processing device 1A, too. As such, the processing circuit can implement the above-described functions by hardware, software, firmware, or a combination thereof.

Note that the present invention is not limited to the above-described embodiments, and a free combination of the embodiments, modifications to any component of each of the embodiments, or omissions of any component in each of the embodiments are possible within the scope of the present invention.

### INDUSTRIAL APPLICABILITY

Image processing devices according to the invention can automatically recognize a road marking even without using images of the road marking shot at a plurality of angles, and thus can be used in, for example, a driving assistance device that assists in vehicle driving on the basis of recognized road markings.

### REFERENCE SIGNS LIST

1, 1A: image processing device, 2, 101: shooting device, 3: marking model DB, 10: marking detecting unit, 11, 11A: road edge detecting unit, 12: road direction estimating unit, 13: image rotating unit, 14: distortion correcting unit, 15: marking recognizing unit, 20, 20A, 20B: target image, 21: road marking, 22a, 22b: white line, 23a, 23b: white region, 24a, 24b, 25a, 25b, 26a, 26b, 27a, 27b: region group, 100: storage device, 102: processing circuit, 103: processor, and 104: memory.

1. An image processing device comprising:
processing circuitry
to detect a road marking drawn on a road from a target image in which the road marking is shot;
to detect, from the target image, road edges of a road region including the detected road marking;
to estimate an angle indicating a direction of the road in the road region, on a basis of slopes of edges of the detected road edges;
to rotate the target image depending on the estimated angle indicating the direction of the road;
to correct distortion of the rotated target image; and
to recognize the road marking using the corrected target image,
wherein the processing circuitry detects white lines in the road region from the target image, and
considers the white lines as the road edges, and estimates the angle indicating the direction of the road in the road region on a basis of slopes of edges of the white lines,
wherein if no white lines are detected from the target image, the processing circuitry determines attributes for respective pixels of the target image, and detects, as the road edges, boundaries each between a region including pixels having a road attribute and a region including pixels having no road attribute, out of the pixels of the target image, and
estimates the angle indicating the direction of the road in the road region, on a basis of slopes of edges of the detected road edges.

2. (canceled)

3. (canceled)

4. The image processing device according to claim 1, wherein the processing circuitry estimates the angle indicating the direction of the road, on a basis of a statistic of slopes of edges of a plurality of line segments lying along the road edges.

5. An image processing method comprising:
detecting a road marking drawn on a road from a target image in which the road marking is shot;
detecting from the target image, road edges of a road region including the detected road marking;
estimating an angle indicating a direction of the road in the road region, on a basis of slopes of edges of the detected road edges;
rotating the target image depending on the estimated angle indicating the direction of the road;
correcting distortion of the rotated target image; and
recognizing the road marking using the corrected target image,
wherein the method includes:
detecting white lines in the road region from the target image, and
considering the white lines as the road edges, and estimating the angle indicating the direction of the road in the road region on a basis of slopes of edges of the white lines; and
if no white lines are detected from the target image, determining attributes for respective pixels of the target image, and detecting, as the road edges, boundaries each between a region including pixels having a road attribute and a region including pixels having no road attribute, out of the pixels of the target image, and
estimating the angle indicating the direction of the road in the road region, on a basis of slopes of edges of the detected road edges.

6. (canceled)

7. (canceled)

8. The image processing method according to claim 3, wherein the method includes estimating the angle indicating the direction of the road, on a basis of a statistic of slopes of edges of a plurality of line segments lying along the road edges.
